(19) United States
(12) Patent Application Publication
(10) Pub. No.: US 2012/0019623 A1
(43) Pub. Date: Jan. 26, 2012

(54) THREE-DIMENSIONAL IMAGE PICKUP APPARATUS AND LENS DRIVING METHOD OF THREE-DIMENSIONAL IMAGE PICKUP APPARATUS

(75) Inventors: TAKASHI KOKUWA, Osaka (JP); KATSUJI KUNISUE, Osaka (JP)

(73) Assignee: PANASONIC CORPORATION, Osaka (JP)

(21) Appl. No.: 13/019,426

(22) Filed: Feb. 2, 2011

(30) Foreign Application Priority Data
Jul. 20, 2010 (JP) 2010-162505

(51) Int. Cl. H04N 13/02

(52) U.S. Cl. 348/47; 348/E13.074

(57) ABSTRACT

A three-dimensional image pickup apparatus for capturing right and left images with a first imaging unit and a second imaging unit to generate a stereoscopic image is provided. In this three-dimensional image pickup apparatus, each of the first imaging unit and the second imaging unit includes a lens group including a zooming lens and a focusing lens, and a imaging device for converting an optical image from the lens group into an electrical signal, and the three-dimensional image pickup apparatus includes a driving controller operable to drive the zooming lens and the focusing lens of the first imaging unit and the second imaging unit, along a tracking curve showing a relationship of a position of the zooming lens and a position of the focusing lens, and the driving controller limits a range of moving the zooming lens and the focusing lens in either one of a first range and a second range, the first range ranges from a wide-angle end in the tracking curve to a inflection point at which the moving direction of the focusing lens is inverted, and the second range ranges from a telephoto end to the inflection point.

### BACKGROUND ART

1. Technical Field

The technical field relates to a three-dimensional image pickup apparatus for capturing a three-dimensional image by using two imaging units.

2. Related Art

A pickup apparatus of a three-dimensional image (3D image) has been brought to attention, which is capable of obtaining a stereoscopic image by independently and simultaneously capturing an image for a left eye and an image for a right eye by using two imaging units. Various proposals have been provided for a display device of three-dimensional image or a viewing method thereof, but all of them provide a three-dimensional effect by using binocular disparity.

In such three-dimensional image pickup apparatus, it is important to suppress a deviation of images due to a deviation of optical axes of two imaging units or the like. As a method of correcting such deviation of optical axes, for example, a method is proposed, which corrects the deviation of optical axes by detecting the deviation amount of optical axes from two images captured by two imaging units, and adjusting a cutting-out area of two images captured by imaging devices on the basis of this deviation amount.

The deviation of images by the two imaging units is particularly distinct in a zoom operation. As a technique for correcting the deviation of images in zoom operation, for example, there is a technique disclosed in JP-A-8-317424. More specifically, in the technique disclosed in JP-A-8-317424, the deviation amount of optical axes about the focal distances by two lenses is stored preliminarily, and an area of image to be read is adjusted depending on the focal length (the position of zoom lenses), and accordingly, the deviation of optical axes caused in relation to the movement of zoom lenses is corrected.

In the three-dimensional image pickup apparatus having two imaging units, there are problems aside from the aforementioned problems. For example, there is a problem that a difference is caused between right and left imaging units in the moving amount of the lenses composing two imaging units, and thus a deviation may be caused in the angle of view or image center of the images obtained in two imaging units.

In light of the above problems, a three-dimensional image pickup apparatus having two imaging units and a lens driving method of a three-dimensional image pickup apparatus are provided, which are capable of suppressing occurrences of deviation in the angle of view or image center in the images obtained by two imaging units.

### SUMMARY

In a first aspect, a three-dimensional image pickup apparatus for capturing right and left images with a first imaging unit and a second imaging unit to generate a stereoscopic image is provided. In this three-dimensional image pickup apparatus, each of the first imaging unit and the second imaging unit includes a lens group including a zooming lens and a focusing lens, and a imaging device for converting an optical image from the lens group into an electrical signal, and the three-dimensional image pickup apparatus includes a driving controller operable to drive the zooming lens and the focusing lens of the first imaging unit and the second imaging unit, along a tracking curve showing a relationship of a position of the zooming lens and a position of the focusing lens, and the driving controller limits a range of moving the zooming lens and the focusing lens in either one of a first range and a second range, the first range ranges from a wide-angle end in the tracking curve to a inflection point at which the moving direction of the focusing lens is inverted, and the second range ranges from a telephoto end to the inflection point.

In a second aspect, a lens driving method for a three-dimensional image pickup apparatus configured to capture right and left images with a first imaging unit and a second imaging unit to generate a stereoscopic image, each of the first and second imaging units including a lens group having a zooming lens and a focusing lens, and a imaging device for converting an optical image from the lens group into an electrical signal is provided. This lens driving method includes driving the zooming lens and the focusing lens in the first imaging unit and the second imaging unit, along a tracking curve showing a positional relationship of the zooming lens and the focusing lens, and limiting a range of moving the zooming lens and the focusing lens in either one of a first range and a second range, the first range ranges from a wide-angle end in the tracking curve to a inflection point at which the moving direction of the focusing lens is inverted, and the second range ranges from a telephoto end to the inflection point.

By the first and second aspects, a range of moving the zooming lens and the focusing lens is limited in either one of a first range from a wide-angle end in the tracking curve to a inflection point at which the moving direction of the focusing lens is inverted, and the second range from a telephoto end to a inflection point at which the moving direction of the focusing lens is inverted. Herein, when both of the ranges are used, the moving direction of the focusing lens is inverted when exceeding the inflection point from the wide-angle end or the telephoto end, and the driving control is complicated, and thereby a deviation is likely to occur in the position of the focusing lens of the first imaging unit and the second imaging unit. In the aspects, however, the range of the moving zooming lens and the focusing lens is limited in either one range as mentioned above. As a result, as compared with the case of using the both ranges, it is possible to reduce the positional deviation of the focusing lens when the position of the zooming lens is changed. Accordingly, it is possible to suppress dispersion of the angle of view of the right and left images. It is further possible to suppress the deviation of the image center due to deviation of optical axes of the imaging units.

### BRIEF DESCRIPTION OF DRAWINGS

FIG. 1 is a block diagram showing a configuration of a three-dimensional image pickup apparatus according to embodiment 1.

FIG. 2 is a block diagram showing a configuration of an imaging unit of the three-dimensional image pickup apparatus according to embodiment 1.

FIG. 3 is a flowchart of operation of the three-dimensional image pickup apparatus according to embodiment 1.

FIG. 4 is a diagram showing tracking curves of the three-dimensional image pickup apparatus according to embodiment 1.

FIG. 5 is a schematic diagram for calculating tracking curves of the three-dimensional image pickup apparatus according to embodiment 1.

FIG. 6 is a schematic diagram of an operation of a lens group of the three-dimensional image pickup apparatus according to embodiment 1.

FIG. 7 is a diagram showing other tracking curves of the three-dimensional image pickup apparatus according to embodiment 1.

FIG. 8 is a diagram showing tracking curves of a three-dimensional image pickup apparatus according to embodiment 2.

### DETAILED DESCRIPTION OF PREFERRED EMBODIMENTS

A three-dimensional image pickup apparatus according to an embodiment is specifically described below by reference to the accompanying drawings.

### Embodiment 1

### 1. Configuration of Three-Dimensional Image Pickup Apparatus

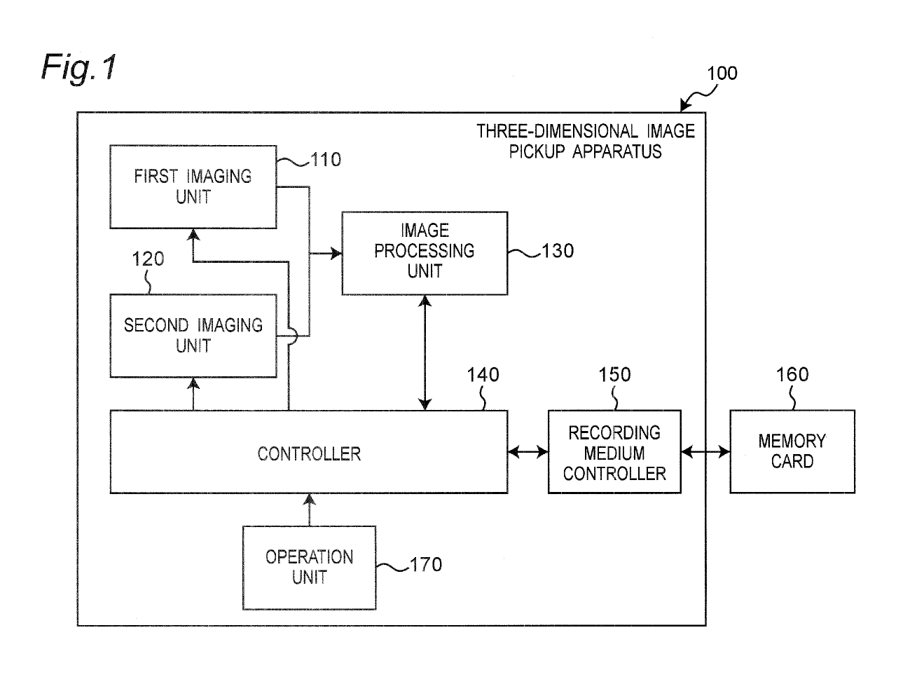

FIG. 1 is a block diagram showing a configuration of a three-dimensional image pickup apparatus 100 according to embodiment 1. In FIG. 1, the three-dimensional image pickup apparatus 100 includes a first imaging unit 110, a second imaging unit 120, an image processing unit 130, a controller 140, a recording medium controller 150, and an operation unit 170. A memory card 160 can be connected to the recording medium controller 150.

The first imaging unit 110 and the second imaging unit 120 are disposed with a specified spacing. The specified spacing is preferably set at about 65 mm, which corresponds to an average distance between two eyes of an adult person, but the spacing is not limited to this distance. The right and left images captured by the first imaging unit 110 and the second imaging unit 120 are processed in the image processing unit 130. The image data subjected to image processing is recorded in the memory card 160 by way of the recording medium controller 150. The captured images may be either still images or moving images.

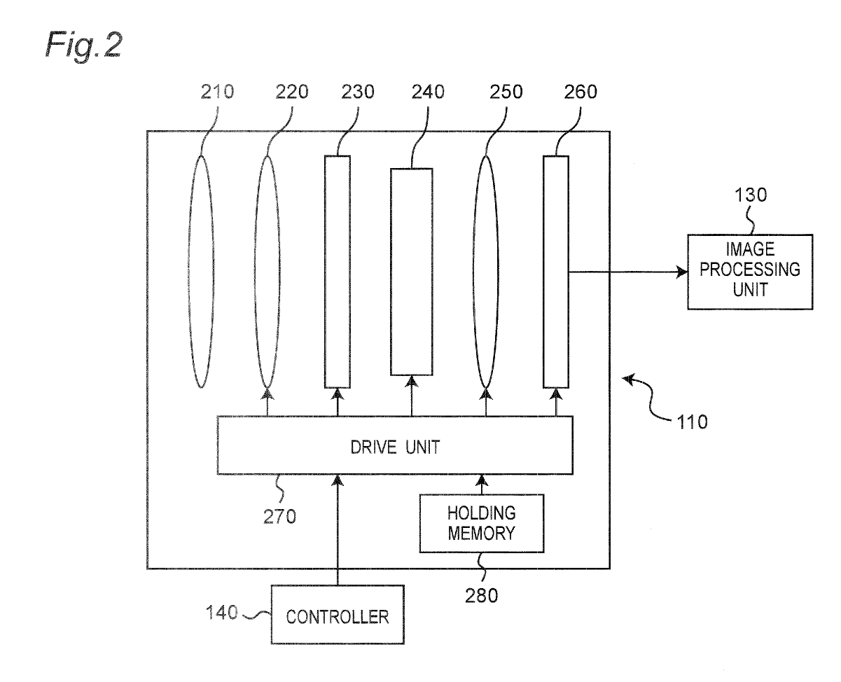

The first imaging unit 110 and the second imaging unit 120 have a same configuration. FIG. 2 shows the detail of the configuration of the first imaging unit 110. The first imaging unit 110 includes an objective lens 210, a zooming lens 220, an iris 230, a camera shake correction unit 240, a focusing lens 250, an imaging device 260, a drive unit 270, and a holding memory 280.

The objective lens 210 is a lens disposed at a side closest to the subject. The zooming lens 220 moves along the optical axis, and can enlarge and reduce a subject image. The zooming lens 220 may be composed of a plurality of lenses. The iris 230 adjusts a size of a aperture either depending on the setting by the user, or automatically, to adjust a quantity of a passing light. The iris 230 includes an ND (Neutral Density) filter and others. The camera shake correction unit 240 has a correction lens capable of moving in a plane vertical to the optical axis. The camera shake correction unit 240 drives the correction lens in a direction of canceling shake of the three-dimensional image pickup apparatus 100, and thereby decrease the blur of the subject image. The focusing lens 250 moves along the optical axis, and adjusts the focus of the subject image. The focusing lens 250 may be composed of a plurality of lenses. The imaging device 260 captures a subject image formed by the lens group to generate image data. The imaging device 260 is a CCD image sensor or a CMOS image sensor. The imaging device 260 may be either a single-plate type, or a three-plate type having imaging devices for each one of R, G, and B signals. The drive unit 270 drives or controls the zooming lens 220, the iris 230, the camera shake correction unit 240, the focusing lens 250, and the imaging device 260. The holding memory 280 stores data to be held by the drive unit 270 even when the power source is cut off. The holding memory 280 can be realized by a flash memory or a ferroelectric memory.

The image processing unit 130 performs AD conversion, pre-processing of image, and compression process. The image pre-processing includes various image processes such as gamma correction, white balance correction, flaw correction to AD converted image data. In image compressing process, the image data is compressed by DCT (discrete cosine transform), Huffman coding, or the like. In the image compressing process, the image data is compressed, for example, by a compression method conforming to MPEG-2 or H.264 standard. The compression method is not limited to the format of MPEG-2 or H.264 alone. The image processing unit 130 may be realized by DSP or microcomputer or the like.

In the embodiment, the configuration of processing the right and left images captured by the first imaging unit 110 and the second imaging unit 120 by one image processing unit 130 is explained. Alternatively, two image processing units 130 may be provided, and the image captured by the first imaging unit 110 and the image captured by the second imaging unit 120 may be processed by different image processing units.

The controller 140 controls the entire three-dimensional image pickup apparatus 100. The controller 140 can be realized by a semiconductor device or the like. The controller 140 may be composed of hardware only, or may be realized by a combination of hardware and software. The controller 140 may be realized by a microcomputer.

The recording medium controller 150 can be loaded with a detachable memory card 160. The memory card 160 can be connected mechanically or electrically to the recording medium controller 150. The memory card 160 includes a flash memory, a ferroelectric memory or the like in the inside, and can store data.

In the embodiment, a configuration that a memory card 160 can be detachably connected to the controller 150 is explained, but the memory card 160 may be built in the three-dimensional image pickup apparatus 100. In this embodiment, the memory card 160 is used as the recording medium, but the recording medium is not limited to the memory card alone, but may be an optical disk, a hard disk, a magnetic tape, or the like.

In the embodiment, the image captured by the first imaging unit 110 and the image captured by the second imaging unit 120 are recorded in one memory card 160, but by connecting two memory cards 160, the image captured by the first imaging unit 110 and the image captured by the second imaging unit 120 may be recorded to different memory cards.

The operation unit 170 is a generic name for various operation means, and includes a power button for turning on or off the power source of the three-dimensional image pickup apparatus 100, a zoom lever for performing a zoom operation, and others. The operation unit 170 receives an instruction from the user, and transmits the instruction to the controller 140.

### 2. Operation of Three-Dimensional Image Pickup Apparatus

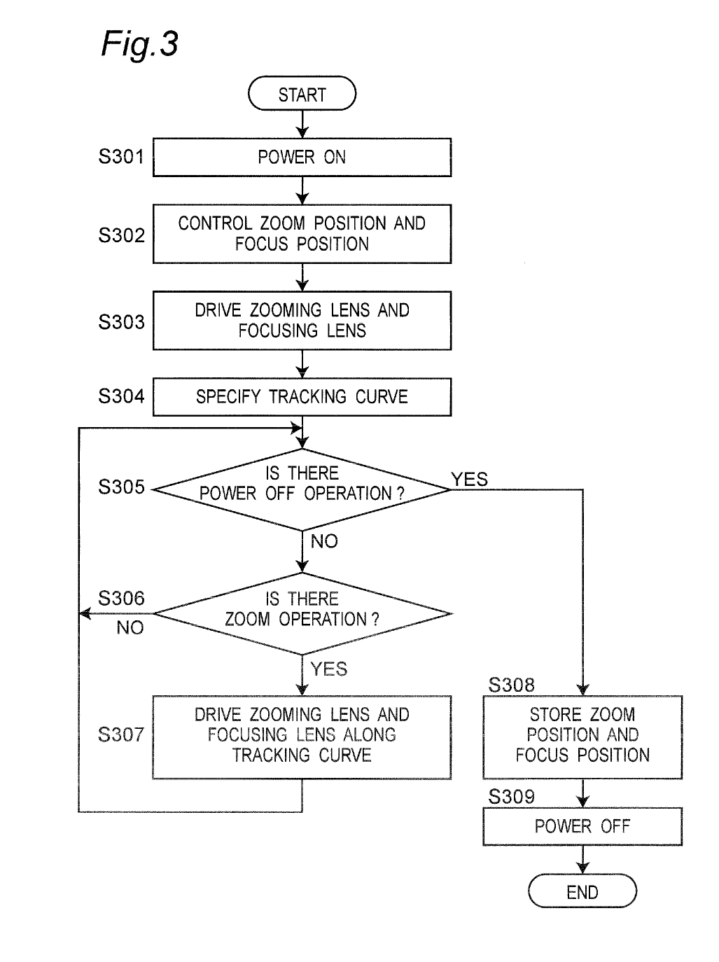

The operation of the three-dimensional image pickup apparatus 100 is explained while referring to the flowchart of FIG. 3.

When the three-dimensional image pickup apparatus 100 is powered on by the user through the operation unit 170, the three-dimensional image pickup apparatus 100 is started (S301). At the time of starting, the controller 140 sends a control signal to driving units 270 of the first imaging unit 110 and the second imaging unit 120 for moving the zooming lens 220 and the focusing lens 250 to the zoom position and the focus position stored immediately before the last power off of the three-dimensional image pickup apparatus 100 in the holding memory 280 (S302). Herein, the zoom position is a position on the optical axis of the zooming lens 220, and is expressed as a relative distance from a predetermined offset position. The focus position is a position on the optical axis of the focusing lens 250, and is expressed as a relative distance from a predetermined offset position.

When each of the driving units 270 of the first imaging unit 110 and the second imaging unit 120 receives the control signal, each unit 270 reads out the zoom position and the focus position stored immediately before the power off in the holding memory 280, from the holding memory 280. When the zoom position and the focus position are read out, the driving unit 270 drives the zooming lens 220 on the basis of the zoom position read out to move the zooming lens 220 to the zoom position immediately before the power off. At the same time, on the basis of the focus position read out, the driving unit 270 drives the focusing lens 250, to move the focusing lens 250 to the focus position immediately before the power off (S303).

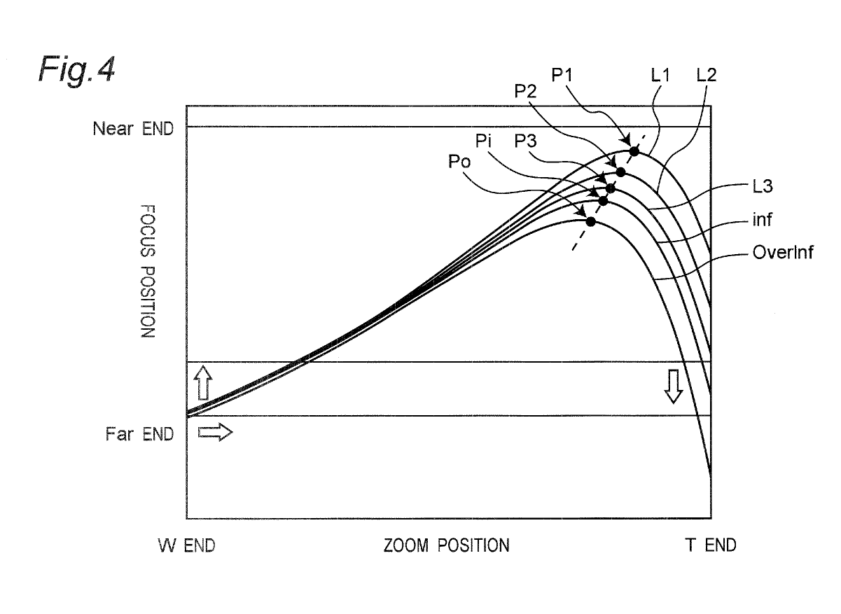

Each of the holding memories 280 of the first imaging unit 110 and the second imaging unit 120 stores the tracking curve to be used in the zoom operation of the zooming lens 220 and the focusing lens 250. The tracking curve shows a relationship of a position of the focusing lens 250 in the optical axis direction (the focus position) to a position of the zooming lens 220 in the optical axis direction (the zoom position), at a specified object point distance. The holding memory 280 stores an ideal tracking curve in a state free from characteristic error in relation to a design value. The ideal tracking curve is obtained from the lens characteristics of the zooming lens 220, the focusing lens 250, and others. By moving the zooming lens 220 and the focusing lens 250 along the tracking curve, it is possible to maintain the in-focus state on the subject in the zoom operation. FIG. 4 shows an example of the tracking curve in the first imaging unit 110. The second imaging unit 120 is same in configuration as the first imaging unit 110, and has a same tracking curve if the individual difference is not taken into consideration.

The tracking curve is expressed by a curve having a inflection point (deflection point). The tracking curve varies with the object point distance. The object point distance is a distance from the three-dimensional image pickup apparatus 100 to an object point on which the three-dimensional image pickup apparatus 100 focuses. As shown in FIG. 4, five tracking curves are prepared corresponding to five kinds of object point distance. In FIG. 4, curves L1, L2, and L3 represent the tracking curves when the object point distance is L1, L2, and L3 (L1<L2<L3). Curve inf shows a tracking curve when the object point distance is infinite. Curve Overinf shows a tracking curve at a virtual object point distance exceeding the infinite point.

Further, the holding memory 280 has a plurality of correction parameters for correcting the deviation caused by individual differences of lens characteristics or the like (the characteristic errors on the design values) of the zooming lens 220 and the focusing lens 250 and others, from the ideal tracking curves shown for FIG. 4. The correction parameters are set individually in the first imaging unit 110 and the second imaging unit 120. When the drive unit 270 receives a control signal for instructing the movement along the ideal tracking curves of the zooming lens 220 and the focusing lens 250 from the controller 140, and refers to a correction parameter on the holding memory 280. On the basis of this correction parameter, the drive unit 270 determines the moving distance for correction of the individual difference respectively in the zooming lens 220 and the focusing lens 250, and drives the zooming lens 220 and the focusing lens 250 by using this moving distance and the tracking curve.

In this embodiment, a configuration of storing five tracking curves L1, L2, L3, inf, and OverInf in the holding memory 280 is explained, but the number of tracking curves is not limited to five, and may be either larger or smaller than this.

Back to FIG. 3, the drive unit 270 selects a tracking curve to be used in a zoom operation on the basis of the present zoom position and focus position (S304). When the present zoom position and focus position are plotted on any curve of the tracking curves L1, L2, L3, or inf, the drive unit 270 uses the plotted curve as the tracking curve. When the present zoom position and the focus position are not plotted on any curve of the tracking curves L1, L2, L3, inf, and OverInf, the drive unit 270 calculates the tracking curve depending on the present object point distance by using the tracking curves L1, L2, L3, inf, and OverInf.

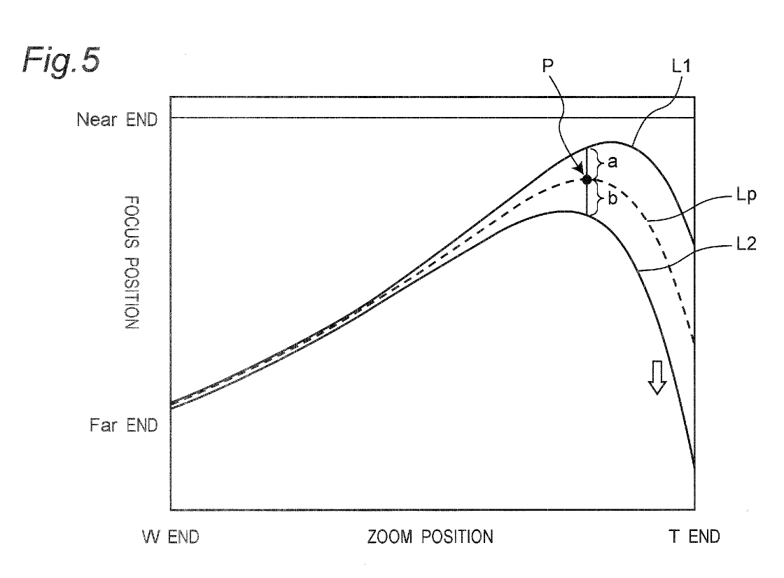

A method of calculating the tracking curve depending on the object point distance is explained by referring to FIG. 5. In FIG. 5, when the present zoom position and the focus position are located at point P, the tracking curves L1 and L2 positioned immediately above and beneath the point P are selected, and a distance (a) to the tracking curve L1 at the zoom position of the point P, and a distance (b) to the tracking curve L2 are determined. A tracking curve Lp is calculated, which provides the ratio of a distance to the tracking curve L1 and a distance to the tracking curve L2 at the zoom position is a: b is calculated. The tracking curve Overinf of the virtual object point distance is provided so as to be capable of calculating the tracking curve depending on the present object point distance, even if the matching zoom position and the focus position to be focused are actually out of the range of the ideal tracking curve inf due to an individual difference of the lens or others. In the embodiment, the method of calculating the tracking curve is an example, and may be other method.

After the tracking curve is specified, the controller 140 judges whether the operation for power off is done by the user by way of the operation unit 170 (S305). When the power off operation is not done, the controller 140 judges whether the zoom operation is carried out or not by the user by way of the operation unit 170 (S306). When the zoom operation is carried out by the user by way of the operation unit 170, the controller 140 causes the first imaging unit 110 and the second imaging unit 120 to perform the zoom operation corresponding to the user's zoom operation instructed by the user in. More specifically, the controller 140 sends out a control signal depending on the amount of the user's zoom operation (for example, the operation time on the operation unit 170), to the drive unit 270 of the first imaging unit 110 and the second imaging unit 120. The drive unit 270 of the first imaging unit 110 and the second imaging unit 120 moves the zooming lens 220 and the focusing lens 250 respectively along the tracking curve corresponding to the present object point distance (S307). As a result, the three-dimensional image pickup apparatus 100 can perform the zoom operation while maintaining the in-focus state.

In particular, when moving the zooming lens 220 and the focusing lens 250 along the tracking curve, the controller 140 according to the embodiment controls the zooming lens 220 to move in a range between a wide end (W end) and a inflection point, and the focusing lens 250 to move in a range between a far end (Far end) and the inflection point. When moving the focusing lens 250, the controller 140 maintains the positional relationship with the zooming lens 220 on the basis of the tracking curve. The inflection point is a point at which change in the value of the focus position changes from increase to decrease (points P1, P2, P3, Pi, and Po in FIG. 4), while the zooming lens 220 is moved from the wide-angle end or the telephoto end. The wide end (W end) is the end of the widest angle-side in the zoom position. The far side (Far side) is the end of the longest distance in the focus position. The controller 140, when zooming from the wide end (W end), sends a control signal for moving the zooming lens 220 and the focusing lens 250 to the first imaging unit 110 and the second imaging unit 120. When zooming from the zoom position of the wide end (W end) of the most wide-angle side, the controller 140 sends a control signal for moving the zooming lens 220 and the focusing lens 250 until a change in the value of the focus position transitions from an increase to a decrease (inflection points P1, P2, P3, Pi and Po in FIG. 4). But the controller 140 does not send a control signal for moving further to the tele end (T end) of the telephoto side from the inflection point, in an area from the inflection point to end of the telephoto side (tele end [T end] side).

The reason of limiting the movement of the zooming lens 220 and the focusing les 250 in this manner is explained below. The lens group composing the first imaging unit 110 and the second imaging unit 120 is driven along an ideal tracking curve. Herein, the first imaging unit 110 and the second imaging unit 120 are identical in specification, but there is actually an individual difference. Accordingly, even if the lens group composing the first imaging unit 110 and the second imaging unit 120 is driven along an ideal tracking curve, it is hard to achieve a strict coincidence of the actual zoom position and the focus position between the first imaging unit 110 and the second imaging unit 120. Moreover, if both the range of the wide-angle side and the telephoto side from the inflection points are used, when the zoom position passes over the inflection point, the moving direction of the focusing lens is inverted. As a result, the driving control is complicated, and the focusing lenses of the first imaging unit and the second imaging unit are likely to be deviated in position. In particular, in the tracking curve shown in FIG. 4, the telephoto side (the tele end [T end] side) from the inflection point is larger in the amount of change of the focus position due to change in the zoom position. Hence, between the first imaging unit 110 and the second imaging unit 120, the actual position and the focus position tend to be deviated. This deviation causes dispersion in the angle of view, or deviation in the center of image between the view captured by the first imaging unit 110 and the view captured by the second imaging unit 120.

In the embodiment, therefore, the controller 140 limits the movement of the lens in a range from the wide end (W end) to the inflection point, within the whole zoom range that can be realized on the basis of the lens characteristics of the zooming lens 220 and the focusing lens 250, thereby not moving to the telephoto side (the tele end [T end] side) from the inflection point. It is hence possible to decrease dispersion in the angle of view, or deviation in the center of image between the view captured by the first imaging unit 110 and the view captured by the second imaging unit 120.

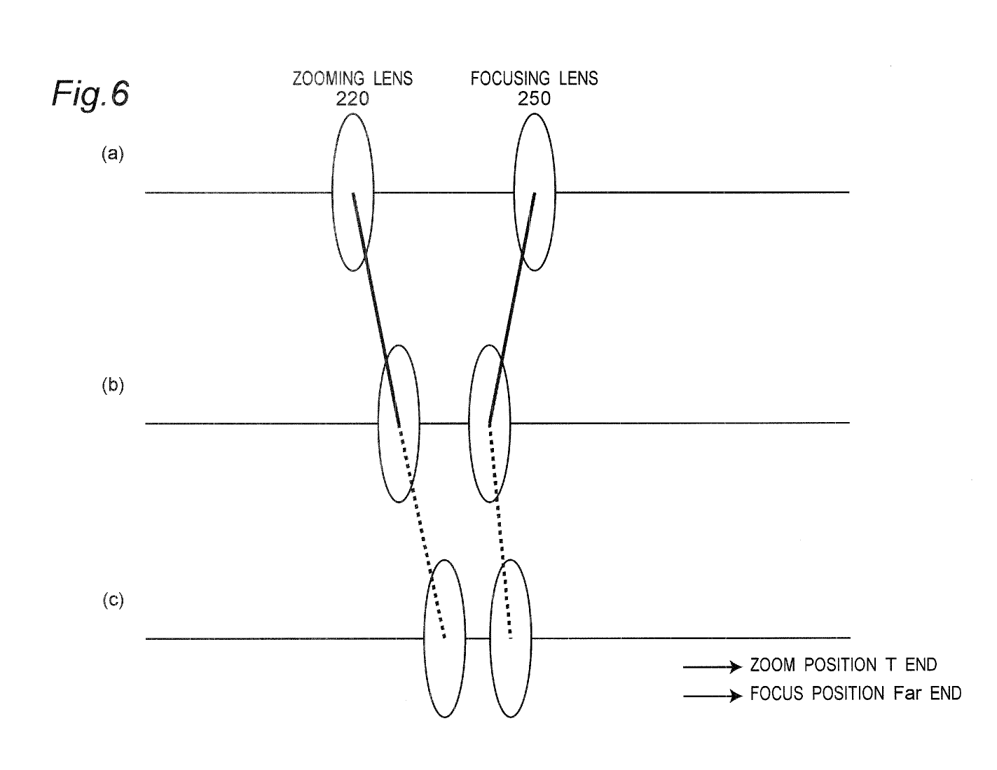

FIG. 6 is a diagram explaining the motion of the zooming lens 220 and the focusing lens 250 along the tracking curve. FIG. 6 (a) shows the position of the zooming lens 220 and the focusing lens 250 before the zoom operation by the user. Along with the zoom operation by the user, the zooming lens 220 moves in a direction approaching the focusing lens 250, and the focusing lens 250 moves in a direction approaching the zooming lens 220. FIG. 6 (b) shows the position of the zooming lens 220 and the focusing lens 250 at the inflection point of the tracking curve. In an ordinary imaging apparatus (a imaging apparatus having only one imaging unit such as the first imaging unit 110 or the second imaging unit 120), as shown in FIG. 6 (c), by using the range of the telephoto side (the tele end [T end] side) from the inflection point, more specifically, by moving the zooming lens 220 successively to the focusing lens 250 side, and moving the focusing lens 250 to the zooming lens 220 side, a zoom operation of a higher multiplying factor is realized. However, when using the range of the telephoto side (the tele end [T end] side) from the inflection point, the moving direction of the focusing lens 250 is inverted at the inflection point. Accordingly, a complicated mechanism is required for coping with this inverted driving. In addition, dispersion between individual pieces and errors are likely to occur, and the deviation due to the individual difference is likely to occur in the images actually captured by the first imaging unit 110 and the second imaging unit 120.

In the embodiment, the controller 140 limits the moving range of the zooming lens 220 and the focusing lens 250 to the position shown in FIG. 6 (b) (the position corresponding to the inflection point), and controls not to move to the position shown in FIG. 6 (c). That is, the moving range of the zooming lens 220 and the focusing lens 250 is limited in a range from the wide-angle side on the tracking curve in FIG. 4, to the inflection point at which the moving direction of the focusing lens 250 is inverted. As a result, as compared with the case of using the both ranges of the range up to the inflection point of inversion of the moving direction of the focusing lens 250, and the range from the telephoto side to the inflection point of inversion of the moving direction of the focusing lens 250, it is possible to decrease the positional deviation of the focusing lens when the position of the zooming lens is changed. Accordingly, it is possible to suppress the dispersion of the angle of view of the right and left images. At the same time, it is also possible to suppress deviation of the image center due to deviation of the optical axes of the imaging units.

In the embodiment, moreover, it is intended to limit the moving range of the zooming lens 220 and the focusing lens 250, in a range in which the change of position of the focusing lens 250 relative to the change of position of the zooming lens 220 is smaller, that is, in a range of the wide-angle side, out of the range up to the inflection point at which the moving direction of the focusing lens 250 is inverted, and the range up to the inflection point of inversion of the moving direction of the focusing lens 250 from the telephoto side. The range in which the change of position of the focusing lens 250 relative to the change of position of the zooming lens 220 is larger is likely to have larger positional deviation of the focusing lens 250 when the position of the zooming lens 220 is changed by a specified amount, as compared with the range of the smaller side. In other words, dispersion of the angle of view of the right and left images are likely to occur. Hence, the range larger in the change of position of the focusing lens 250 relative to the change of position of the zooming lens 220 is not used in the zoom operation, and only the range of the smaller change is used in the zoom operation. As a result, as compared with the case of using the both ranges, it is possible to decrease the positional deviation of the focusing lens 250 when the position of the zooming lens is changed by a specified amount. Accordingly, it is possible to suppress the dispersion of the angle of view of the right and left images. At the same time, it is also possible to suppress deviation of the image center due to deviation of the optical axes between the first imaging unit 110 and the second imaging unit 120.

Back to FIG. 3, again, when the power source is cut off by the user by way of the operation unit 170 (Yes at S305), the controller 140 sends an instruction to the drive unit 270 for storing the present zoom position of the zooming lens 220 and the focus position of the focusing lens 250 to the holding memory 280 (S308). Next, the controller 140 controls to cut off the power source of the three-dimensional image pickup apparatus 100 (S309).

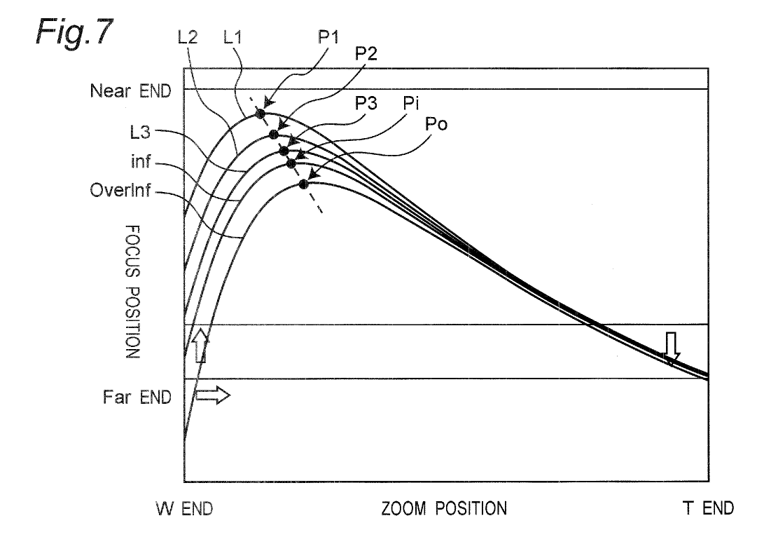

As shown in FIG. 7, meanwhile, on the tracking curve, if the change in focusing lens position between the inflection point and the tele end (T end) is smaller than the change in the focusing lens position between the inflection point and the wide end (W end), the moving range of the zooming lens 220 and the focusing lens 250 may be limited in the range between the telephoto side and the inflection point on the tracking curve. In this case, too, the same effects as in the above embodiment can be obtained.

### 3. Summary

The three-dimensional image pickup apparatus 100 according to the embodiment captures right and left images with the first imaging unit 110 and the second imaging unit 120 to generate a stereoscopic image. The first imaging unit 110 and the second imaging unit 120 include the lens group having the zooming lens 220 and the focusing lens 250, and the imaging device 260 for converting an optical image from the lens group into an electrical signal. The three-dimensional image pickup apparatus 100 has the controller 140 for driving the zooming lens 220 and the focusing lens 250 in the first imaging unit 110 and the second imaging unit 120, along the tracking curve showing the positional relationship between the zooming lens 220 and the focusing lens 250. The controller 140 limits the range of moving the zooming lens 220 and the focusing lens 250, in either one of a first range and a second range. The first range ranges from the wide-angle side of the tracking curve to the inflection point at which the moving direction of the focusing lens 250 (the first range) is inverted, and the second range ranges the range from the telephoto end to the inflection point.

By this configuration, as mentioned above, it is possible to decrease the positional deviation of the focusing lens 250 when the position of the zooming lens 220 is changed. Accordingly, it is possible to suppress the dispersion of the angle of view of the right and left images. At the same time, it is also possible to suppress deviation of the image center due to deviation of the optical axes between the first imaging unit 110 and the second imaging unit 120.

In the embodiment above-described, it is intended to use the range in which change of position of the focusing lens relative to the change of position of the zooming lens is smaller, out of the range from the wide-angle side on the tracking curve up to the inflection point at which the moving direction of the focusing lens is inverted, and the range from the telephoto side up to the inflection point at which the moving direction of the focusing lens is inverted. But not limited to this relation alone, the moving range of the zooming lens and the focusing lens may be limited in a range which provides the wider moving range of the zooming lens, out of the range from the wide-angle side of the tracking curve to the inflection point at which the moving direction of the focusing lens is inverted, and the range from the telephoto side to the inflection point at which the moving direction of the focusing lens is inverted (for example, between the wide-angle end and the inflection point in FIG. 4, or between the telephoto end and the inflection point in FIG. 7). As a result, while holding the zoom amount, it is possible to suppress dispersion of the angle of view of the right and left images, or deviation of the image center.

Either one of the range from the wide-angle side of the tracking curve to the inflection point at which the moving direction of the focusing lens is inverted, or the range from the telephoto side to the inflection point at which the moving direction of the focusing lens is inverted can be regarded to be as the range continuing to increase or decrease in the value of the focusing lens, from the wide-angle side or the telephoto side of the tracking curve.

### Embodiment 2

As embodiment 2, other methods of limiting the movement of the zooming lens and the focusing lens along the tracking curve are explained below.

The configuration and the operation flowcharts of the three-dimensional image pickup apparatus 100 according to embodiment 2 are same as those in embodiment 1, and detailed description is omitted.

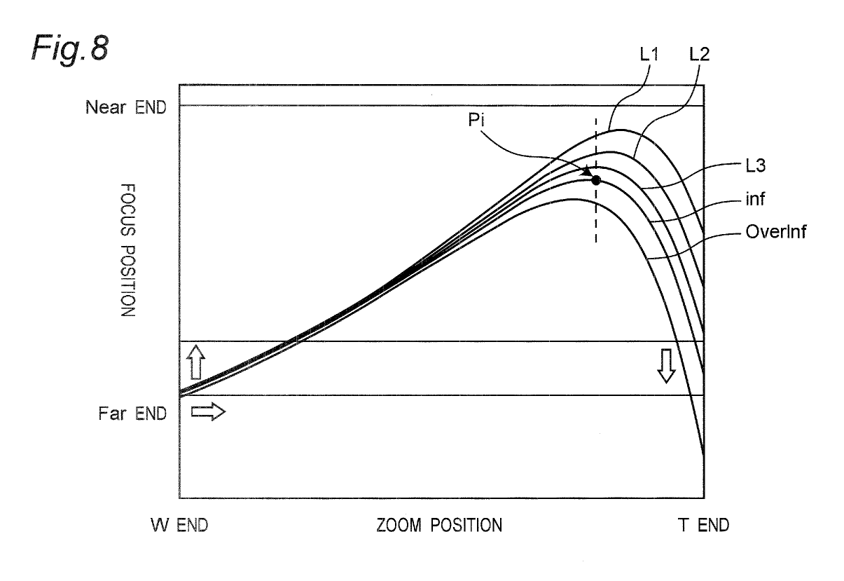

FIG. 8 shows tracking curves in embodiment 2. In FIG. 8, the controller 140 limits the movement of the zooming lens 220 and the focusing lens 250 in a range up to the zoom position of the inflection point (Pi) on the tracking curve for the distance of the object point which is infinite (curve inf), in all object point distances when performing a zoom operation from the wide end (W end) at the most wide-angle position of the zoom position.

The inflection points of tracking curves at other object point distances are positioned at the telephoto side (the tele end (T end) side from the inflection point of the tracking curve for the distance of the object point which is infinite. Therefore, by limiting the zoom position up to the inflection point of the tracking curve for the distance of the object point which is infinite, at all object point distances, the movement of the zooming lens 220 and the focusing lens 250 along the tracking curve can be limited up to immediately before the inflection point of each tracking curve from the wide end (W end). As a result, it is possible to decrease dispersion of the angle of view and the deviation in the image center occurring between the image captured with the first imaging unit 110 and the image captured with the second imaging unit 120. Further, the controller 140 does not determine the inflection points of tracking curves at all object point distances, but determines the inflection point only about the tracking curve for the distance of the object point which is infinite. It is hence possible to lessen the load of processing when determining the inflection point.

### Other Embodiments

Embodiments 1 and 2 are presented herein as preferred embodiments, but other embodiments are further described herein together. It must be noted, however, that these changes and modifications are also included in the technical concept of the foregoing embodiments.

In embodiments 1 and 2, the controller 140 limits the moving range of the zooming lens 220 and the focusing lens 250, in a range from the wide-angle side to the inflection point on the tracking curve. However, the zoom position for limiting the movement is not limited to the inflection point, and may include any zoom position, as far as the zoom position is in a range from the wide-angle side to the inflection point. The zoom position for limiting the movement is not strictly limited to the inflection point. For example, if the zoom position is at the telephoto side from the inflection point, as far as the individual fluctuations of the mechanism for inverting drive are small, and the zoom position is a zoom position that a change of the focus position accompanying the change of the zoom position is small, the technical concept of the embodiments are applicable.

In embodiments 1 and 2, the holding memory 280 of the first imaging unit 110 and the second imaging unit 120 stores the tracking curves shown in FIG. 4 and the correction parameters due to the individual difference of the lenses. But without having the holding memory 280 in the first imaging unit 110 and the second imaging unit 120, the controller 140 may store the tracking curves and the parameters, or the first imaging unit 110 and the second imaging unit 120 may store the own correction parameters only, and the controller 140 may store the tracking curves.

### INDUSTRIAL APPLICABILITY

The three-dimensional image pickup apparatus according to the embodiments is capable of decreasing the deviation of the angle of view and image center of the right and left images occurring in the zoom operation, and is applicable in the three-dimensional image pickup apparatus for professional and consumer use, and it is very useful.

What is claimed is:

1. A three-dimensional image pickup apparatus for capturing right and left images with a first imaging unit and a second imaging unit to generate a stereoscopic image, wherein
each of the first imaging unit and the second imaging unit comprises:
a lens group comprising a zooming lens and a focusing lens, and
a imaging device operable to convert an optical image from the lens group into an electrical signal, and
the three-dimensional image pickup apparatus comprises a driving controller operable to drive the zooming lens and the focusing lens of the first imaging unit and the second imaging unit along a tracking curve showing a relationship of a position of the zooming lens and a position of the focusing lens, and
the driving controller limits a range of moving the zooming lens and the focusing lens in either a first range or a second range, the first range ranges from a wide-angle end in the tracking curve to a inflection point at which a moving direction of the focusing lens is inverted, and the second range ranges from a telephoto end to the inflection point.

2. The three-dimensional image pickup apparatus according to claim 1, wherein the driving controller limits the moving range of the zooming lens and the focusing lens, in a range in which a change in position of the focusing lens relative to a change in position of the zooming lens is smaller, out of the first range and the second range.

3. The three-dimensional image pickup apparatus according to claim 1, wherein the driving controller limits the moving range of the zooming lens and the focusing lens, in a range which provides a wider moving range of the zooming lens, out of the first range and the second range.

4. The three-dimensional image pickup apparatus according to claim 1, wherein the driving controller stores a plurality of tracking curves depending on a distance of an object point, and generates a tracking curve depending on the distance of the object point to a subject on a basis of the stored tracking curves.

5. The three-dimensional image pickup apparatus according to claim 4, wherein the driving controller calculates a inflection point on the tracking curve for the distance of the object point which is infinite, and limits a movement of the zooming lens and the focusing lens, in a range from the wide-angle end or the telephoto end, to a zoom position for the calculated inflection point on the tracking curves at all object point distances.

6. A lens driving method for a three-dimensional image pickup apparatus configured to capture right and left images with a first imaging unit and a second imaging unit to generate a stereoscopic image, each of the first and second imaging units including a lens group having a zooming lens and a focusing lens, and a imaging device for converting an optical image from the lens group into an electrical signal,
wherein the lens driving method comprises:
driving the zooming lens and the focusing lens of the first imaging unit and the second imaging unit along a tracking curve showing a positional relationship of the zooming lens and the focusing lens, and
limiting a range of moving the zooming lens and the focusing lens in either a first range or a second range, the first range ranges from a wide-angle end in the tracking curve to a inflection point at which a moving direction of the focusing lens is inverted, and the second range ranges from a telephoto end to the inflection point.

7. The lens driving method in a three-dimensional image pickup apparatus according to claim 6, wherein, the limiting of the moving range limits the moving range of the zooming lens and the focusing lens, in a range in which a change in position of the focusing lens relative to the a change in position of the zooming lens is smaller, out of the first range and the second range.

8. The lens driving method in a three-dimensional image pickup apparatus according to claim 6, wherein, the limiting of the moving range limits the moving range of the zooming lens and the focusing lens, in a range which provides a wider moving range of the zooming lens, out of the first range and the second range.

9. The lens driving method in a three-dimensional image pickup apparatus according to claim 6, further comprising:
storing a plurality of tracking curves depending on a distance of an object point, and
generating a tracking curve depending on the distance of the object point to the subject on a basis of the stored tracking curves.

10. The lens driving method in a three-dimensional image pickup apparatus according to claim 9, wherein the generating of the tracking curve calculates inflection points on the tracking curve for the distance of the object point which is infinite, and limits a movement of the zooming lens and the focusing lens, in a range from the wide-angle end or the telephoto end, to a zoom position for the calculated inflection point on the tracking curves at all object point distances.
